(19) United States
(12) Patent Application Publication
(10) Pub. No.: US 2003/0096082 A1
(43) Pub. Date: May 22, 2003

(54) Copper alloy foil

(76) Inventors: Hifumi Nagai, Hitachi-shi (JP); Toshiteru Nonaka, Hitachi-shi (JP)

Correspondence Address: JORDAN AND HAMBURG LLP, 122 EAST 42ND STREET, SUITE 4000, NEW YORK, NY, 10168, US

(21) Appl. No.: 10/193,576

(22) Filed: Jul. 11, 2002

(30) Foreign Application Priority Data
Jul. 13, 2001 (JP) 2001-214439

(51) Int. Cl. B32B 1/00

(52) U.S. Cl. 428/141; 428/423.1; 428/425.8

(57) ABSTRACT

For a two-layer printed wiring board including a polyimide substrate produced with varnish containing polyamic acid as the raw material for the polyimide and a copper alloy foil laminated with the polyimide substrate, there is provided, as the copper alloy foil, a copper alloy foil having good wettability with the varnish and a low surface roughness that enables direct bonding with polyimide without roughening plating processing of the copper alloy foil. The copper alloy of the foil contains at least one of 0.01-2.0 weight percent Cr and 0.01-1.0 weight percent Zr or contains 1.0-4.8 weight percent Ni and 0.2-1.4 weight percent Si. Good wettability with the varnish is obtained by setting the thickness of anticorrosive coating on the copper alloy foil to less than 5 nm; the surface roughness is less than 2 μm expressed as ten-point average surface roughness (Rz); and, without roughening and plating processing, the 180° C. peel strength when peeling from film of the polyimide as the substrate obtained by thermosetting polyamic acid is greater than 8.0 N/cm.

### BACKGROUND OF THE INVENTION

The present invention relates to a copper alloy foil used in a laminate for a printed wiring board.

Printed wiring boards are used frequently in the electronic circuitry of electronic equipment. Printed wiring boards are classified broadly as either rigid laminates (i.e., rigid boards) or flexible laminates (i.e., flexible boards), according to the type of resin serving as the substrate. Flexible boards, which are characterized by flexibility, are used not only for wiring in flexible regions but also as space-saving wiring material, because they can be housed within electronic equipment in the folded state. Also, because the board itself is thin, it also can be used in semiconductor package interposer applications and as a liquid-crystal display IC tape carrier. In flexible boards, polyimide often is used as the resin that serves as the substrate, and copper generally is used as the conductive material because of its conductivity. Structurally, a flexible board is either a three-layer flexible board or a two-layer flexible board. A three-layer flexible board is structured such that a resin film (e.g., polyimide) and a copper foil, the conductive material, are bonded by means of an adhesive (e.g., epoxy resin, acrylic resin). On the other hand, a two-layer flexible board is structured such that copper, the conductive material, is adhesively bonded directly to a resin (e.g., polyimide). The term “resin” as used throughout the present specification and claims means “synthetic polymer”.

In a printed wiring board, the copper foil of the copper-clad laminate is etched to form various wiring patterns, after which electronic components are connected and mounted by means of solder. However, heat resistance is required because the material of a printed wiring board is repeatedly subjected to considerably high temperatures. In recent years, lead-free solder has been used more frequently to protect the environment. However, because its melting point is higher than that of conventional lead solder, the heat resistance requirement of flexible boards has become more stringent. As a result, in two-layer flexible boards, only polyimide resin, which has excellent heat resistance, is used as an organic material, so heat resistance can be improved more easily than in three-layer flexible boards, which use adhesives with inferior heat resistance (e.g., epoxy resins, acrylic resins). Thus the usage of polyimide resins has increased.

The principal methods used to produce two-layer flexible boards with a polyimide resin as the substrate are the metallizing method, the laminate method, and the casting method. In the metallizing method, a method such as sputtering is used to deposit a thin layer of metal (e.g., Cr) on a polyimide film, after which sputtering, plating, or the like, is used to form the necessary thickness of copper, the conductive material of the printed wiring board. So, no copper foil is used. In the laminate method, copper foil, which serves as the conductive material of the printed wiring board, is laminated directly onto the polyimide film. In the casting method, varnish containing polyamic acid, the precursor of polyimide resin, the substrate, is applied to a copper foil, the conductive material of the printed wiring board, and the polyimide film formed by thermosetting becomes the resin substrate.

With the miniaturization, weight-saving, and enhanced functionality of electronic equipment in recent years, there has been increased demand for high-density mounting on printed wiring boards, resulting in finer pitches with narrower line widths and line or wire spacing in electronic circuits. If copper foil with high surface roughness or copper foil with irregularities formed by a roughening process is used as the conductive material, when a circuit is formed by etching, etching residue containing residual copper remains in the resin, so the etching linearity drops, leading to nonuniform circuit widths. As a result, copper foil with low surface roughness is preferable, to enable finer pitches in an electronic circuit. Also, higher-frequency electrical signals are being utilized in electronic equipment (e.g., PCs, mobile telecommunications). However, when the electrical signal frequency exceeds 1 GHz, the skin effect (i.e., the flow of current only on the surface of a conductor) becomes significant, so the effect of variation in the transmission path caused by surface irregularities can no longer be disregarded. Therefore, attempts were made to form a metal film on a flat polyimide film, as in the metallization method, thereby to obtain a copper surface less rough than the surface of the copper foil used in the laminate method or the casting method.

The copper foil that serves as the conductive material in a printed wiring board is classified as a rolled copper foil or an electrolytic copper foil, depending on its production process. Electrolytic copper foil is produced by electrolytically depositing copper from a copper sulfate plating bath onto a titanium or stainless steel drum. However, it has become possible to produce so-called low-profile foil, which is copper foil produced by adding additives to the plating bath and then regulating the electrolytic deposition conditions to reduce the surface roughness. Rolled copper foil is produced by using a rolling roll to plastically form it, so the surface pattern of the rolling roll is transferred to the foil surface, thereby yielding a smooth surface. Furthermore, the foil generally is less than 100 μm thick.

To improve its adhesion to a resin, the copper foil used in a printed wiring board is subjected to a roughening plating process that utilizes electroplating to form copper particles on the surface of the copper foil. This improves the adhesion by means of the so-called anchor effect, i.e., the irregularities formed on the copper foil surface cause the copper foil to bite into the resin, thereby yielding a mechanical adhesive strength. For the aforesaid reasons, however, it is desirable to bond a copper foil with low surface roughness to a resin film, without performing roughening plating processing, so it is necessary to maintain the adhesive strength without performing roughening plating processing. Also, in a three-layer flexible board, an attempt was made to coat copper foil with a silane coupling agent, and so forth, in order to improve the adhesive strengths of the copper foil, which is a metal, and the adhesive, which is an organic material. However, because the 300-400° C. production temperature used for a two-layer flexible board is higher than the 100-200° C. temperature used for a three-layer flexible board, the coupling agent pyrolyzes readily, so the adhesion is not improved.

A copper alloy containing pure copper and small quantities of additional elements is used as the raw material of the copper foil used as the conductive material. As a finer pitches are utilized in electronic circuits, the copper foil (i.e., the conductor) thins and the circuit narrows, so two copper foil properties are desired: low DC resistance loss and high conductivity. Copper is a material with excellent conductivity, so pure copper with a high purity (above 99.9%) generally is used in the aforesaid field, where conductivity is important. However, copper's strength decreases as its purity increases, so if the copper foil is thinned, its handleability deteriorates. Therefore, a high copper foil strength is preferable.

### SUMMARY OF THE INVENTION

Under such circumstances, the present inventors found that it is possible to strengthen copper foil and improve adhesion to polyimide film, without reducing conductivity, by producing foil by using a copper alloy that is based on pure copper, which has superior conductivity, and that contains small quantities of additional elements, for which Japanese Patent Application No. 2001-21986 was filed. Although foil obtained by rolling a copper alloy in this manner had low surface roughness, it was possible to produce a copper-clad laminate with good adhesion to polyimide film, without roughening plating processing, by using the laminate method, so superior high-frequency characteristics were obtained. An attempt was made to produce a two-layer flexible board with a polyimide resin as the substrate, by using a casting method as well as this copper alloy foil. After varnish containing polyamic acid, the precursor of polyimide, was applied to the copper alloy foil instead of adhering the polyimide film to the copper alloy foil, polyimide film was formed by thermosetting. As a result, it was determined that, depending on the state of the copper alloy foil's surface, the wettability with varnish containing polyamic acid sometimes was poor, so varnish adhered unevenly, making it difficult to obtain a uniformly thick polyimide film by thermosetting.

The present invention provides a copper alloy foil for a laminate such that, when a casting method is used to produce a two-layer printed wiring board with a polyimide resin as the substrate, the wettability of the copper alloy foil with varnish containing polyamic acid is improved, so it is possible to create a uniformly thick polyimide film by thermosetting, without uneven varnish adhesion; and such that it yields a tensile strength greater than 600 N/mm², preferably greater than 650 N/mm²; a target conductivity (for a copper alloy foil for a laminate, having superior conductivity) greater than 40% IACS, preferably greater than 50% IACS; a surface roughness, expressed as ten-point average surface roughness (Rz), less than 2 μm; and an adhesive strength expressed as a 180° peel strength greater than 8.0 N/cm, without performing special processing, such as roughening plating processing.

In studying the cause of uneven varnish adhesion when coating a copper alloy foil with varnish containing polyamic acid, the present inventors discovered that the wettability of varnish and copper alloy foil sometimes was poor because of the anticorrosive coating for preventing the tarnishing of the copper alloy foil. An organic compound containing nitrogen (e.g., benzotriazole, imidazole) which forms a chelate with copper frequently is used to prevent the tarnishing of pure copper and copper alloys. By controlling the thickness of these anticorrosive coatings, the wettability with varnish containing polyamic acid became excellent, so it was possible to obtain a uniform polyimide film thickness by thermosetting. They also discovered that the adhesion with polyimide having polyamic acid as the raw material was improved by using a copper alloy that was based on pure copper, which has superior conductivity, and that contained small quantities of additional elements. Moreover, the surface roughness was less than 2 μm expressed as ten-point average surface roughness (Rz), and sufficient adhesion with the film formed by thermosetting polyamic acid was obtained even without roughening plating processing. Concretely, as a result of considerable research regarding the effects of various additional elements on such properties as the wettability of polyamic acid and the anticorrosive coating, and on the adhesion to polyimide formed by thermosetting polyamic acid, the present invention provides

(1) a copper alloy foil for a laminate, characterized in that it contains at least one of the components Cr (0.01-2.0 weight percent) and Zr (0.01-1.0 weight percent), and the remainder consists of copper and unavoidable impurities; it has an anticorrosive coating less than 5 nm thick; it has properties such that the surface roughness is less than 2 μm expressed as ten-point average surface roughness (Rz), the tensile strength is greater than 600 N/mm², and the conductivity is greater than 50% IACS; the wettability with varnish containing polyamic acid is good; and the 180° peel strength between the copper alloy foil and a film produced by thermosetting polyamic acid without roughening plating processing of the copper alloy foil is greater than 8.0 N/cm.; and

(2) a copper alloy foil for a laminate, characterized in that it contains 1.0-4.8 weight percent Ni and 0.2-1.4 weight percent Si, and the remainder consists of copper and unavoidable impurities; it has an anticorrosive coating less than 5 nm thick; it has properties such that the tensile strength is greater than 650 N/mm², and the conductivity is greater than 40% IACS; the wettability with varnish containing polyamic acid is good; and the 180° peel strength between the copper alloy foil and a film produced by thermosetting polyamic acid without roughening plating processing of the copper alloy foil is greater than 8.0 N/cm.

Also, in the present invention, Ag, Al, Be, Co, Fe, Mg, Ni, P, Pb, Si, Sn, Ti, and Zn each has the effect of increasing the strength of a copper alloy mainly by means of solid solution strengthening or hardening, so one or more of these elements can be added to the copper alloys of the invention but proportions of Ni and Si to be used in embodiment (2) are only those within the ranges stated hereinabove in the summary of embodiment (2). If the total content is less than 0.005 weight percent, the aforesaid desired effect cannot be obtained. On the other hand, if it exceeds 2.5 weight percent, the conductivity, solderability, and workability deteriorate considerably, so the total contents of Ag, Al, Be, Co, Fe, Mg, Ni, P, Pb, Si, Sn, Ti, and Zn can be within the range 0.005-2.5 weight percent, but with the aforementioned exception for the proportions of Ni and Si in embodiment (2).

According to another aspect of the present invention, copper alloy foils according to hereinabove paragraph (2) have a surface roughness of less than 2 μm, expressed as ten-point average surface roughness (Rz).

The reasons for the aforesaid limitations on the surface state, the alloy composition, and so forth, in the present invention will be discussed next.

(1) Anticorrosive coating: Tarnishing of pure copper and copper alloys commonly is prevented by using an organic material containing nitrogen (e.g., benzotriazole, imidazole) to form a chelate with the copper on the surface, thereby forming an anticorrosive coating. On the other hand, these anticorrosive coatings are water-repellent, so they reduce the wettability with liquids, causing varnish containing polyamic acid to be repelled. So, by limiting the anticorrosive coating thickness to less than 5 nm, it becomes possible to achieve a uniform varnish coating thickness, so it becomes possible to reduce variation in the thickness of polyimide obtained by heating the polyamic acid to cause an imidization reaction. The anticorrosive coating thickness may be reduced by reducing the concentration of the anticorrosive agent, for example. When using benzotriazole as the anticorrosive agent, it is preferable to reduce the concentration to less than 500 ppm. The thickness of the anticorrosive coating can be quantified—by measuring by means of Auger electron spectroscopy. That is, Auger electron spectroscopy can be used to analyze in the depth direction. So the depth from the surface of the copper alloy foil to the point at which the detected intensity of nitrogen, the element that constitutes the anticorrosive agent, equals that of the background is measured.

(2) Cr, Zr: It is known that, during the production of a resin, Cr and Zr function as catalysts that promote polymerization. As a result, it is believed that the addition of these to copper during alloy foil production promotes bonding between the metal and the polyimide resin, thereby strengthening the interfacial bond. If too little of these is added, their catalytic function is insufficient, so the metal and the resin are bonded insufficiently, resulting in little improvement in adhesion. It is necessary to impart a 180° peel strength of at least 8.0 N/cm to avoid problems during its application to printed wiring boards. It was determined that, to obtain this property, the added amount of at least either Cr or Zr must be greater than 0.01 weight percent. On the other hand, when more is added, coarse crystallization products result from segregation during casting. The metal material containing the coarse crystallization products develops cracks during hot rolling, so the hot rollability deteriorates. Also, as finer pitches are utilized in electronic circuits, the copper foil (i.e., the conductor) thins and the circuit narrows, so two copper foil properties are desired: low DC resistance loss and high conductivity. Moreover, when more is added, the conductivity sometimes drops. The maximum added amounts of Cr and Zr at which these problems do not occur are, respectively and by weight, 2.0 percent, more preferably 0.4 percent, for Cr, and 1.0 percent, more preferably 0.25 percent, for Zr. This is because plastic forming is performed easily. Therefore, for the copper alloy foil for the laminate of a printed wiring board, the appropriate ranges of the added alloy components are, by weight, 0.01-2.0 percent, more preferably 0.01-0.4 percent, for Cr; and 0.01-1.0 percent, more preferably 0.01-0.25 percent, for Zr.

(3) Ni, Si: It is known that Ni functions as a catalyst that promotes polymerization during the production of a resin. As a result, it is believed that the addition of Ni to copper during alloy foil production promotes bonding between the metal and the polyimide resin, thereby strengthening the interfacial bond. If too little of this is added, its catalytic function is insufficient, so the metal and the resin are bonded insufficiently, resulting in little improvement in adhesion. It is necessary to impart a 180° peel strength of at least 8.0 N/cm to avoid problems during its application to printed wiring boards. Also, Si forms the precipitate Ni₂Si with Ni, which has the effects of increasing the copper's strength and increasing the conductivity. At Ni contents less than 1.0 weight percent or at Si contents less than 0.2 weight percent, the desired strength is not obtained as a result of the aforesaid behavior.

On the other hand, when the Ni and Si contents are increased, coarse crystallization products that do not contribute strength occur during casting. The metal material containing the coarse crystallization products develops cracks during hot rolling, and they appear on the material surface during cold rolling, thereby generating surface defects. Also, if the content is increased, the conductivity drops considerably, so it no longer is suitable as a conductive material for circuits. The maximum added amounts at which these problems do not occur are, respectively and by weight, less than 4.8 percent, more preferably less than 3.0 percent, for Ni; and less than 1.4 percent, more preferably 1.0 percent, for Si. This is because plastic forming is performed easily. Consequently, for the copper alloy foil for the laminate of a printed wiring board, the appropriate content ranges for the alloy components are, by weight, 1.0-4.8 percent, more preferably 1.0-3.0 percent, for Ni; and 0.2-1.4 percent, more preferably 0.2-1.0 percent, for Si.

(4) Surface roughness: When the copper alloy's surface roughness increases, the skin effect, by which current flows only in the surface of a conductor when the electric signal frequency exceeds 1 GHz, increases the impedance, thereby affecting the transmission of high-frequency signals. So, it is necessary to reduce the surface roughness of conductive materials in high-frequency circuit applications. The relationship between the surface roughness and the high-frequency characteristics was studied. As a result, it was determined that the surface roughness of copper alloy foil for the laminate of a printed wiring board should be less than 2 μm expressed as ten-point average surface roughness (Rz). Methods of reducing the surface roughness include optimizing the conditions used for the production of rolled copper foil and electrolytic copper foil, and chemically polishing or electrolytically polishing the copper foil surface. It generally is possible to easily reduce the surface roughness of the work roll of the rolling mill, thereby reducing the work roll profile transferred to the copper foil.

(5) Tensile strength and conductivity: Strength and conductivity generally are related inversely, so the higher the material strength, the lower the conductivity tends to be. When the tensile strength is less than 600 N/mm², handling, and so forth, readily produces wrinkles. Also, when the conductivity is below 40% IACS, it is undesirable as a conductive material for a laminate. Conditions suitable for a copper alloy foil for a laminate are a tensile strength greater than 600 N/mm², and a conductivity greater than 40% IACS. A tensile strength greater than 650 N/mm² is preferable for a copper alloy foil for a laminate, that has high strength and superior handling. A conductivity greater than 50% IACS is preferable for a copper alloy foil for a laminate, that has excellent conductivity.

(6) 180° peel strength: When the 180° peel strength is low, there is danger of peeling from the laminate, so an adhesive strength, i.e., a 180° peel strength, greater than 8.0 N/cm is required.

The copper alloy foil of the present invention is in no way limited in the production method. For example, it is possible to use a rolled copper foil production method in which an alloy or an electrolytic copper foil produced by means of an alloy plating method is fused, cast, and rolled. An example rolling method will be discussed next. Predetermined quantities of alloy elements are added to fused, pure copper, after which this is cast in a mold to create an ingot.

In the present invention, active elements (Cr, Zr) are added, so in order to inhibit the generation of oxides, etc., it is preferable to perform this in a vacuum or in an inert gas atmosphere. It also is preferable to use electrolytic copper with a low oxygen content or oxygen-free copper as the raw material. Hot rolling is used to thin the ingot to a certain thickness, after which the top layer is scraped off and the ingot is subjected to repeated cold rolling and annealing. Finally, cold rolling is performed to finish the foil. The rolling-finished material is coated with rolling oil, so acetone, a petroleum solvent, or the like, is used for degreasing.

If an oxide layer is formed during annealing, it will cause trouble in subsequent processing, so it is necessary either to perform annealing in a vacuum or in an inert gas atmosphere, or to remove the oxide layer after annealing. For example, to remove the oxide layer by pickling, it is preferable to use sulfuric acid+hydrogen peroxide, nitric acid+hydrogen peroxide, or sulfuric acid+hydrogen peroxide+fluoride.

### DETAILED DESCRIPTION OF THE INVENTION

The embodiments of the present invention will be explained next.

For copper alloy production, oxygen-free copper, the principal raw material, was fused in an Ar atmosphere in a high-purity graphite crucible by using a high-frequency vacuum induction melting furnace. To this were added, as auxiliary materials, additional materials selected from among a copper-chrome master alloy, a copper-zirconium master alloy, aluminum, silver, a copper-beryllium master alloy, cobalt, iron, magnesium, nickel, a copper-phosphorus master alloy, lead, a copper-silicon master alloy, tin, titanium, and zinc. This was then cast in a mold. This method yielded a copper alloy ingot that was 30 mm thick, 50 mm wide, 150 mm long, and weighed approximately 2 kg. This ingot was heated to 900° C., and hot rolling was used to roll it to a thickness of 8 mm. The oxide scale was then removed, after which cold rolling and various heat treatments were performed to obtain a copper alloy foil rolled to a thickness of 35 μm.

Rolling oil adhered to the 35-μm-thick copper alloy foil obtained by means of the aforesaid method, so the foil was immersed in acetone to remove the oil. It was then immersed in an aqueous solution containing 10 weight percent sulfuric acid and 1 weight percent hydrogen peroxide, to remove the surface oxide layer and the anticorrosive coating. To investigate the effects of the anticorrosive coating thickness, the foil was then immersed in an aqueous solution with a regulated benzotriazole concentration and then dried immediately. Other than this, no special surface processing (e.g., roughening plating processing, silane coupling processing) was used to improve adhesion. The copper alloy foil prepared in this manner was attached to a coating machine, and an applicator was used to apply varnish containing polyamic acid and N-methylpyrrolidone as the solvent. The solvent was evaporated from the varnish film in a vacuum dryer, after which, as the final step, the film was maintained at 350° C. for 10 min. to form a polyimide film by thermosetting the polyamic acid, thereby yielding a copper-clad laminate consisting of two layers: polyimide and a copper alloy. Here, the polyimide film thickness was approximately 50 μm.

The following methods were used to evaluate the hot rollability, surface roughness, conductivity, tensile strength, anticorrosive coating thickness, and adhesive strength with polyimide film, of the copper alloy foil obtained in this manner:

(1) Hot rollability: The hot rollability was evaluated by subjecting the hot-rolled material to penetrant inspection and by visually inspecting the exterior for cracks in the material.

(2) Surface roughness: The surface roughness was measured transversely to the rolling direction by using a stylus-type surface roughness tester. The measurement conditions complied with the method described in JIS B 0601, and the surface roughness was evaluated by using the ten-point average surface roughness (Rz).

(3) Conductivity: Regarding the conductivity, the electrical resistance at 20° C. was determined by using a DC four-probe method that utilized a double bridge. For the measurement sample, copper foil processed to a thickness of 35 μm was cut to a width of 12.7-mm. The conductivity was determined by measuring the electrical resistance at an inter-measurement length of 50 mm.

(4) Tensile strength: The tensile strength was measured at room temperature by means of a tensile strength test. The measurement sample was obtained by using a precision cutter to cut, into 12.7-mm-wide and 150-mm-long strips, the copper foil processed to a thickness of 35 μm. This was measured at a tension speed of 50 mm/min. and a gauge length of 50 mm.

(5) Anticorrosive coating thickness: As mentioned previously, Auger electron spectroscopy was used to perform depth profiling, and the depths from the surface to the points at which the detected intensity of nitrogen (i.e., the element that constituted the anticorrosive agent) equaled the background were measured.

(6) Adhesive strength: Regarding the adhesive strength, the 180° peel strength was measured in conformity with the method described in JIS C 5016. For the measurement, double-sided tape was used to attach the copper alloy foil to the tensile tester, and the polyimide was peeled by bending it in the 180° direction. With the peel width set at 5.0 mm, the adhesive strength was measured at a tension speed of 50 mm/min.

(1) Embodiment 1

Table 1 lists the composition of the copper alloy foil containing at least one of Cr and Zr according to the first embodiment of the invention, and Table 2 lists the results of the evaluation of the properties of the copper alloy foil. In each case, the oxygen content was at most 10 ppm. Furthermore, a hyphen (−) in the table indicates that no measurement was taken. This is because, in the copper alloy foil containing Zn or Pb, there was considerable evaporation of alloy components during oxygen analysis, so accurate measurement of the oxygen content was impossible. It is assumed, however, that the oxygen content was at most 10 ppm in each case. Regarding hot rollability, ∘ indicates those lacking cracks after hot rolling, and X indicates those with cracks. Those with cracks were not subjected to subsequent testing. Also, regarding varnish applicability, copper foil was coated with a varnish containing polyamic acid, after which the varnish state was checked. “Varnish applicability” means wettability of the copper alloy foil with the varnish. Regarding varnish applicability, ∘ indicates that even adherence of the varnish was observed, and X indicates that uneven adherence to the varnish was observed. Examples 1-14 are embodiments of the copper alloy foil of the present invention. As is evident in Table 1, the copper alloy foil of the present invention had a conductivity exceeding 50% IACS, a tensile strength exceeding 600 N/mm², and a 180° peel strength exceeding 8.0 N/cm. It was determined that it has superior conductivity and handleability, and that it has high adhesive strength. Also, none developed cracks during hot rolling.

TABLE 1

| | | Chemical Composition | | | | | | | | | | | | | | | | |
|---|---|---|---|---|---|---|---|---|---|---|---|---|---|---|---|---|---|---|
| | | | | | | | | | | | | | | | | | | Cu & |
| | | (%) | | | | | | | | | | | | | | | (ppm) | Unavoidable |
| | No. | Cr | Zr | Ag | Al | Be | Co | Fe | Mg | Ni | P | Pb | Si | Sn | Ti | Zn | O | Impurities |
| Examples | 1 | 0.17 | — | — | — | — | — | — | — | — | — | — | — | — | — | — | 5 | Remainder |
| of the | 2 | 1.5 | — | — | — | — | — | — | — | — | — | — | — | — | — | — | 8 | Remainder |
| invention | 3 | — | 0.18 | — | — | — | — | — | — | — | — | — | — | — | — | — | 4 | Remainder |
| | 4 | — | 0.47 | — | — | — | — | — | — | — | — | — | — | — | — | — | 10 | Remainder |
| | 5 | 0.47 | 0.46 | — | — | — | — | — | — | — | — | — | — | — | — | — | 4 | Remainder |
| | 6 | 0.19 | 0.09 | — | — | — | — | — | — | — | — | — | — | — | — | 0.21 | — | Remainder |
| | 7 | 0.38 | 0.17 | — | — | — | — | — | — | — | — | — | — | — | — | 0.11 | — | Remainder |
| | 8 | 0.32 | — | — | — | — | — | — | — | 0.72 | — | — | — | 0.71 | 0.5 | — | 3 | Remainder |
| | 9 | 0.76 | 0.15 | — | — | — | — | — | 0.05 | — | — | — | — | — | — | — | 8 | Remainder |
| | 10 | 0.96 | — | — | — | — | — | 0.1 | — | — | — | 0.06 | 0.11 | — | — | — | — | Remainder |
| | 11 | 0.71 | — | 0.11 | — | — | — | — | — | — | 0.04 | 0.15 | — | — | — | — | — | Remainder |
| | 12 | 0.18 | — | — | 0.01 | — | 0.6 | 1.4 | — | — | — | 0.01 | — | 0.45 | — | — | — | Remainder |
| | 13 | 0.22 | — | — | — | — | — | — | — | — | — | — | — | 0.27 | — | 0.17 | — | Remainder |
| | 14 | — | 0.18 | — | — | 0.22 | 0.61 | — | — | 1.2 | — | — | — | — | — | — | 7 | Remainder |
| Comparative | 15 | — | — | — | — | — | — | — | — | — | — | — | — | — | — | — | 4 | Remainder |
| examples | 16 | 0.007 | — | — | — | — | — | — | — | — | — | — | — | — | — | — | 4 | Remainder |
| | 17 | — | 0.004 | — | — | — | — | — | — | — | — | — | — | — | — | — | 4 | Remainder |
| | 18 | 2.4 | — | — | — | — | — | — | — | — | — | — | — | — | — | — | 6 | Remainder |
| | 19 | — | 1.4 | — | — | — | — | — | — | — | — | — | — | — | — | — | 10 | Remainder |
| | 20 | 0.28 | — | — | — | — | — | — | — | — | — | — | — | — | 2.7 | — | 5 | Remainder |
| | 21 | 0.38 | 0.17 | — | — | — | — | — | — | — | — | — | — | — | — | 0.11 | — | Remainder |
| | 22 | 0.38 | 0.17 | — | — | — | — | — | — | — | — | — | — | — | — | 0.11 | — | Remainder |

TABLE 2

| | | Hot | | Thickness of | | | | 180° |
|---|---|---|---|---|---|---|---|---|
| | | Rollability | Surface | Anticorrosive | | Tensile | | Peel |
| | | (◯: good | Roughness | Coating | Conductivity | Strength | Varnish | Strength |
| | No. | X: poor) | (Rz) (μm) | (nm) | (% IACS) | (N/mm²) | Applicability | (N/cm) |
| Examples | 1 | ◯ | 1.2 | 1 | 85 | 630 | ◯ | 9.2 |
| of the | 2 | ◯ | 1 | 1 | 69 | 780 | ◯ | 11 |
| invention | 3 | ◯ | 1.3 | 1 | 90 | 610 | ◯ | 9.4 |
| | 4 | ◯ | 1.3 | 1 | 75 | 640 | ◯ | 10 |
| | 5 | ◯ | 1 | 1 | 83 | 650 | ◯ | 12.5 |
| | 6 | ◯ | 0.9 | 1 | 70 | 720 | ◯ | 9.5 |
| | 7 | ◯ | 1 | 1 | 84 | 730 | ◯ | 11.6 |
| | 8 | ◯ | 1 | 1 | 55 | 820 | ◯ | 11.2 |
| | 9 | ◯ | 0.9 | 1 | 82 | 660 | ◯ | 12.3 |
| | 10 | ◯ | 1.3 | 2 | 80 | 700 | ◯ | 9.3 |
| | 11 | ◯ | 1.1 | 1 | 66 | 720 | ◯ | 10.5 |
| | 12 | ◯ | 1 | 1 | 52 | 690 | ◯ | 12.4 |
| | 13 | ◯ | 0.9 | 1 | 75 | 680 | ◯ | 11.8 |
| | 14 | ◯ | 0.9 | 1 | 55 | 810 | ◯ | 10.7 |
| Comparative | 15 | ◯ | 1.4 | 2 | 99 | 400 | ◯ | 7.5 |
| examples | 16 | ◯ | 1.4 | 1 | 93 | 480 | ◯ | 8.4 |
| | 17 | ◯ | 1.3 | 1 | 97 | 520 | ◯ | 8.9 |
| | 18 | X | — | | — | — | | — |
| | 19 | X | — | | — | — | | — |
| | 20 | ◯ | 0.8 | 1 | 11 | 950 | ◯ | 10.4 |
| | 21 | ◯ | 1 | 7 | 84 | 730 | X | — |
| | 22 | ◯ | 1 | 12 | 84 | 730 | X | — |

On the other hand, Comparative Example 15 in Table 1 is a rolled copper foil to which the alloy components of the present invention were not added. An ingot produced by fusing and casting oxygen-free copper in an Ar atmosphere was processed into foil, after which this was adhered to polyimide. Because the raw material was pure copper, the conductivity was high. However, this yielded insufficient adhesive strength (180° peel strength: 7.5 N/cm), leading to concern that the copper foil might peel off after being applied to a printed wiring board.

Comparative Examples 16 and 17 were processed into foil by means of the method used for the examples according to the invention, after adding only Cr or Zr, respectively. Because the Cr and Zr concentrations were less than 0.01% by weight, they were ineffective in improving the strength, and their tensile strengths were low (less than 600 N/mm²).

In Comparative Example 18, Cr was added, but it was added in a concentration exceeding 2.0 mass percent by weight, so coarse Cr crystallization products occurred during casting and cracks occurred during hot rolling, resulting in poor hot rollability. In Comparative Example 19, only Zr was added, but its concentration exceeded 1.0 weight percent, so cracks similarly occurred during hot rolling. As a result, Comparative Examples 18 and 19 could not be subjected to subsequent testing.

In Comparative Example 20, Ti was added, but its concentration exceeded 2.5 weight percent, so the conductivity was low, making it unsuitable for the conductive material of printed wiring boards.

Comparative Examples 21 and 22 were processed by immersing the alloy foil of Example 7 in an aqueous solution with a regulated benzotriazole concentration. As a result, as the anticorrosive coating thickened, the wettability with varnish containing polyamic acid decreased, so varnish variation was detected. This made it impossible to obtain a uniform polyimide film, so it was impossible to measure the 180° peel strength.

(2) Embodiment 2

Table 3, in Examples 23-32, lists the composition of the copper alloy foil containing Ni and Si according to the second embodiment of the invention, and Table 4 lists the results of the evaluation of the properties of the copper alloy foil. Each oxygen content was below 10 ppm. Furthermore, in Table 3, the dash symbol (−) indicates that no measurement was made. This is because, in the copper alloy foil containing Zn or Pb, there was considerable evaporation of alloy components during oxygen analysis, so accurate measurement of the oxygen content was impossible. It is assumed, however, that the oxygen content was at most 10 ppm in each case. Regarding hot rollability, in Table 4, ∘ indicates those lacking cracks after hot rolling, and X indicates those with cracks. Those with cracks were not subjected to subsequent testing. Regarding surface defects, in Table 4, ∘ indicates absence of notable surface defects and X indicates presence of notable surface defects. Also, regarding varnish applicability, copper foil was coated with a varnish containing polyamic acid, after which the varnish state was checked. Regarding varnish applicability, in Table 4, ∘ indicates that even adherence to the varnish was observed, and X indicates that uneven adherence to the varnish was observed. As is evident in Table 4, the copper alloy foil of the present invention had a conductivity exceeding 40% IACS, a tensile strength of at least and generally exceeding 650 N/mm², and a 180° peel strength after adhesion to polyimide exceeding 8.0 N/cm. It was determined that it has superior conductivity and handleability as well as high adhesive strength. Also, none developed cracks during hot rolling.

TABLE 3

| | | Chemical Composition | | | | | | | | | | | | | |
|---|---|---|---|---|---|---|---|---|---|---|---|---|---|---|---|
| | | (%) | | | | | | | | | | | | | Cu & Unavoidable |
| | No. | Ni | Si | Ag | Al | Be | Co | Fe | Mg | P | Pb | Sn | Ti | Zn | Impurities |
| Examples | 23 | 1.4 | 0.33 | — | — | — | — | — | — | — | — | — | — | — | Remainder |
| of the | 24 | 2.5 | 0.52 | — | — | — | — | — | — | — | — | — | — | — | Remainder |
| invention | 25 | 3.1 | 0.62 | — | — | — | — | — | — | — | — | — | — | — | Remainder |
| | 26 | 2.5 | 0.74 | 0.09 | — | — | — | — | — | — | — | — | — | 0.24 | Remainder |
| | 27 | 2.4 | 0.64 | — | — | — | — | — | 0.15 | — | — | — | 0.3 | — | Remainder |
| | 28 | 3.1 | 0.39 | — | — | — | — | 0.3 | — | — | — | 0.58 | — | — | Remainder |
| | 29 | 2.8 | 0.37 | — | 0.55 | — | — | — | — | — | 0.06 | — | — | — | Remainder |
| | 30 | 3.2 | 0.71 | — | — | — | — | — | — | 0.04 | — | — | — | 0.1 | Remainder |
| | 31 | 1.7 | 0.54 | — | — | — | — | — | 0.05 | — | — | — | 0.54 | — | Remainder |
| | 32 | 2.6 | 0.48 | — | — | 0.11 | 0.6 | — | — | — | — | — | — | — | Remainder |
| Comparative | 33 | — | — | — | — | — | — | — | — | — | — | — | — | — | Remainder |
| examples | 34 | 3.5 | 0.04 | — | — | — | — | — | — | — | — | — | — | — | Remainder |
| | 35 | 0.65 | 0.22 | — | — | — | — | — | — | — | — | — | — | — | Remainder |
| | 36 | 5.2 | 0.39 | — | — | — | — | — | — | — | — | — | — | — | Remainder |
| | 37 | 3.2 | 1.9 | — | — | — | — | — | — | — | — | — | — | — | Remainder |
| | 38 | 2.8 | 0.8 | — | — | — | — | 2.9 | — | — | — | — | — | — | Remainder |
| | 39 | 2.4 | 0.48 | — | — | — | — | — | — | — | — | — | 3.0 | — | Remainder |
| | 40 | 3.1 | 0.62 | — | — | — | — | — | — | — | — | — | — | — | Remainder |

TABLE 4

| | | Hot | Surface | Thickness of | | | | |
|---|---|---|---|---|---|---|---|---|
| | | Rollability | Defects | Anticorrosive | | Tensile | | 180° Peel |
| | | (◯: good | (◯: good | Coating | Conductivity | Strength | Varnish | Strength |
| | No. | X: poor) | X: poor) | (nm) | (% IACS) | (N/mm²) | Applicability | (N/cm) |
| Examples | 23 | ◯ | ◯ | 2 | 64 | 660 | ◯ | 9.3 |
| of the | 24 | ◯ | ◯ | 1 | 52 | 750 | ◯ | 10.3 |
| invention | 25 | ◯ | ◯ | 1 | 48 | 800 | ◯ | 11.6 |
| | 26 | ◯ | ◯ | 1 | 51 | 790 | ◯ | 9.4 |
| | 27 | ◯ | ◯ | 2 | 48 | 650 | ◯ | 12.6 |
| | 28 | ◯ | ◯ | 3 | 42 | 720 | ◯ | 12.2 |
| | 29 | ◯ | ◯ | 2 | 41 | 730 | ◯ | 9.4 |
| | 30 | ◯ | ◯ | 1 | 62 | 820 | ◯ | 9.6 |
| | 31 | ◯ | ◯ | 1 | 56 | 660 | ◯ | 11.0 |
| | 32 | ◯ | ◯ | 2 | 50 | 810 | ◯ | 11.1 |
| Comparative | 33 | ◯ | ◯ | 2 | 99 | 400 | ◯ | 7.5 |
| examples | 34 | ◯ | ◯ | 2 | 37 | 610 | ◯ | 10.8 |
| | 35 | ◯ | ◯ | 2 | 68 | 640 | ◯ | 7.6 |
| | 36 | ◯ | X | 1 | 38 | 800 | ◯ | 10.3 |
| | 37 | X | — | | — | — | — | — |
| | 38 | ◯ | ◯ | 1 | 23 | 780 | ◯ | 12.1 |
| | 39 | ◯ | ◯ | 3 | 14 | 930 | ◯ | 10.1 |
| | 40 | ◯ | ◯ | 6 | 48 | 800 | X | — |

On the other hand, Comparative Example 33 in Table 3 is a rolled copper foil to which the alloy components of the present invention were not added. An ingot produced by fusing and casting oxygen-free copper in an Ar atmosphere was processed into foil, after which this was adhered to polyimide. Because the raw material was pure copper, the conductivity was high. However, this yielded insufficient adhesive strength (180° peel strength: 7.5 N/cm), leading to concern that the foil might peel off after being applied to a printed wiring board. Also, the handleability was poor because the tensile strength was low, namely, less than 650 N/mm².

Comparative Examples 34 and 35 were processed into foil by means of the method used for Examples 23-32, after adding Ni and Si. In Comparative Example 34, the Si concentration was less than 0.2 weight percent, so the tensile strength was low (<650 N/mm²), and the conductivity also was low (<40% IACS). Also, in Comparative Example 35, the Ni concentration was less than 1.0 weight percent, so it was insufficient to improve the adhesion. The 180° peel strength was low (<8.0 N/cm), and the tensile strength also was low (<650 N/mm²).

Although Ni and Si were added in Comparative Example 36, the Ni was added in a concentration exceeding 4.8 weight percent, so coarse crystallization products occurred, resulting in many surface defects, which reduced the conductivity. Although Ni and Si were added in Comparative Example 37, the Si was added in a concentration exceeding 1.4 weight percent, so cracks occurred during hot rolling, thereby degrading the hot rollability. As a result, Comparative Example 37 could not be subjected to subsequent testing.

In Comparative Examples 38 and 39, Fe and Ti, respectively, were added in addition to Ni and Si, but Fe and Ti were added in concentrations exceeding 2.5 weight percent, so the conductivity was low, making them unsuitable as a conductive material in a printed wiring board.

Comparative Example 40 was processed by immersing the alloy foil of Example 25 in an aqueous solution with a benzotriazole concentration regulated at 6000 ppm. As a result, as the anticorrosive coating was 6 nm thick, the wettability with varnish containing polyamic acid decreased, so irregular varnish application was detected. This made it impossible to obtain a uniform polyimide film, so it was impossible to measure the 180° peel strength.

When used for a printed wiring board laminate with varnish containing polyamic acid as the raw material and with thermoset polyimide as the substrate, the copper alloy foil of the present invention has low surface roughness and superior adhesion, and it has high conductivity and strength. For these reasons, it is ideal for applications requiring a conductive material for an electronic circuit that requires fine wiring.

1. Copper alloy foil for lamination with a polyimide substrate, the copped alloy foil consisting essentially of at least one of 0.01-2.0 weight percent Cr and 0.01-1.0 weight percent Zr, the balance copper and unavoidable impurities, the copper alloy foil having an anticorrosive coating of thickness less than 5 nm, the copper alloy foil having a surface exhibiting no roughening plating processing, and having a surface roughness less than 2 μm expressed as ten-point average surface roughness and exhibiting good wettability with a varnish containing polyamic acid, tensile strength greater than 600 N/mm² and conductivity greater than 50% IACS, and 180° peel strength between the copper alloy foil and the polyimide substrate is greater than 8.0 N/cm.

2. Copper alloy foil for lamination with a resin substrate, the copper alloy foil consisting essentially of 1.0-4.8 weight percent Ni, 0.2-1.4 weight percent Si, the balance copper and unavoidable impurities, the copper alloy foil having an anticorrosive coating of thickness less than 5 nm, the copper alloy foil having a surface exhibiting no artificial roughening and exhibiting good wettability with a varnish containing polyamic acid, tensile strength greater than 650 N/mm² and conductivity greater than 40% IACS, and 180° peel strength between the copper alloy foil and the polyimide is greater than 8.0 N/cm.

3. Copper alloy foil according to claim 2, wherein the copper alloy foil has a surface roughness less than 2 μm expressed as ten-point average surface roughness.

4. Copper alloy foil according to claim 1, 2 or 3, wherein the anticorrosive coating comprises at least one nitrogen-containing organic compound which forms a chelate with the copper.

5. Copper alloy foil according to claim 4, wherein the organic compound is selected from the group consisting of benzotriazole and imidazole.

6. A laminate comprising a copper alloy foil according to claim 1, 2 or 3 laminated with a polyimide substrate.

7. A laminate according to claim 5, wherein the polyimide substrate is a polyimide film.
